(19) United States
(12) Patent Application Publication
(10) Pub. No.: US 2010/0297930 A1
(43) Pub. Date: Nov. 25, 2010

(54) Portable Device with a Vehicle driver Detection

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/707,659

(22) Filed: Feb. 17, 2010

Related U.S. Application Data
(63) Continuation-in-part of application No. 12/646,297, filed on Dec. 23, 2009.
(60) Provisional application No. 61/180,119, filed on May 20, 2009.

(51) Int. Cl. H04W 88/02; H04K 3/00

(52) U.S. Cl. 455/1; 455/566

(57) ABSTRACT

Detection of a user sitting in a driver's seat is used to prevent operation of a specified function of a portable device. For example, the cell phone can be prevented from texting when the user is sitting in the driver's seat.

This application claims priority from provisional application No. 61/180,119, filed May 20, 2009; the entire contents of which are herewith incorporated by reference.

This is a continuation in part of application Ser. No. 12/646,297, filed Dec. 23, 2009, the entire contents of which are herewith incorporated by reference.

### BACKGROUND

My co-pending application Ser. No. 12/646,297 describes different techniques of preventing a driver from using a portable electronic device such as a handheld phone improperly while driving. In some of those embodiments, different techniques are used to discriminate between the driver and other non-driver occupants of the vehicle. The driver is prevented from using the portable device improperly while other users are allowed to use the portable device.

Texting while operating a moving vehicle has been linked with causing accidents. More generally, operating any keyboard while operating a vehicle can be dangerous.

### SUMMARY

The present application describes detecting that a driver is using a portable device improperly. According to an embodiment, as described herein, different techniques are used in the phone for preventing the user from operating the device in an improper way.

An embodiment describes the use of an operation circuit in the portable device. In an embodiment, the portable device is a portable telephone. This detects whether a driver is actually in the driver's seat. When the phone is detected to be in the driver's seat, the operation circuit executes an operation which prevents the phone from being used for improper uses.

### BRIEF DESCRIPTION OF THE DRAWINGS

FIG. 1 shows a first embodiment;

FIG. 2 shows operation in an automobile;

FIGS. 3A-3D show sectoring with a vehicle;

FIGS. 4 and 5 show placement of electrodes;

FIG. 6 shows a steering wheel embodiment;

FIG. 7 shows a dual hand embodiment;

FIG. 8 shows a directional embodiment;

FIG. 9 shows an embodiment with sectoring from the point of view of a driver's seat

FIG. 10 shows a basic embodiment of a portable phone with an operation circuit;

FIG. 11 shows a phone with a number of electrodes thereon;

FIG. 12 shows a flowchart of the different functions that are carried out by the operation circuit;

FIG. 13 shows how the functions can be attached to a vehicle; and

FIG. 14 shows a schematic diagram of one operation circuit that can be used.

### DETAILED DESCRIPTION

An embodiment describes detecting a velocity of a cell phone user; e.g, a driver of an automobile who is using a cell phone. For example, this can be detected using triangulation between cell towers, or using a global positioning system in the phone (“GPS”). Alternative embodiments can use a velocity detecting device such as a velocity sensor. or a camera can be used to take pictures of the surroundings to detect the velocity from the movement of the pictures of the surroundings.

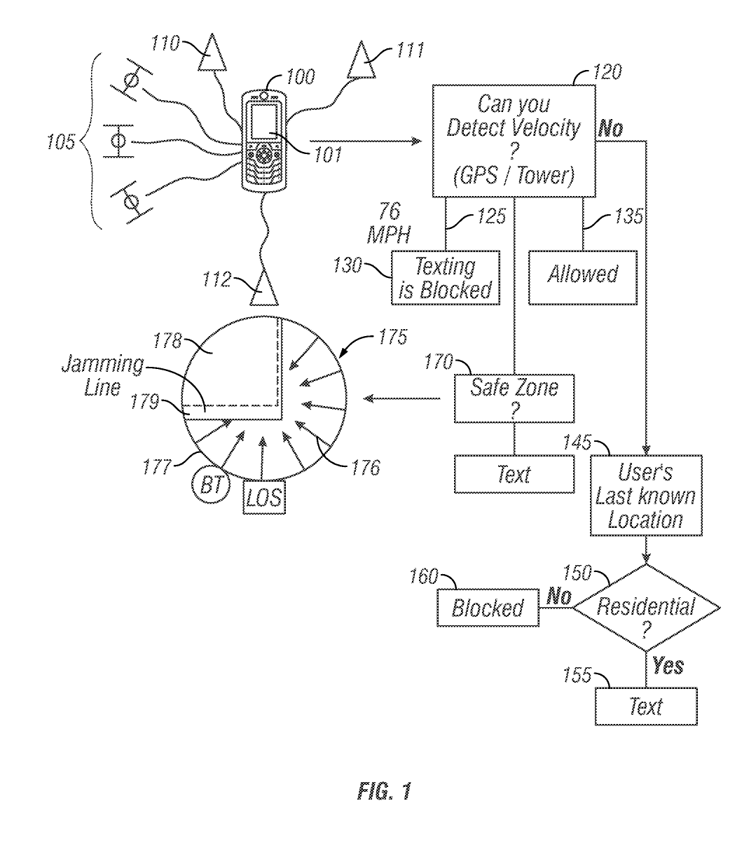

FIG. 1 shows the phone 100 detecting information from GPS satellites 105. Only three GPS satellites are shown, but it should be understood that many more than three may satellites be communicating with the phone. FIG. 1 also shows the phone communicating with the communication towers 110, 111, 112 and contemplates a triangulation between towers. Again, it should be understood that the triangulation can be between fewer or more towers.

The operation is carried out by the controller, for example a dedicated processing device 101 within the phone 100 which runs the routine described herein.

At 120, the processor detects whether the velocity can be detected. For example, the velocity may be detectable via GPS or towers as explained above. In one embodiment, if the velocity is greater than a specified speed, for example 6 miles an hour at 125, use of the keyboard may be prohibited in one or more ways, e.g, for texting and/or e-mailing at 130. This prevention of using the keyboard is referred to herein as “prevention of texting”, it being understood that other uses of the keyboard may analogously be prevented. In the embodiments, the value of the speed may be selected, but the speed may be one that at which it is presumed that the user is traveling in an automobile and not walking.

If the velocity is less than 6 miles an hour at 135, texting and e-mailing is allowed at 140. When the texting is blocked, this may prevent all of the texting options, for example it may cause each of the texting options to be “grayed out” on the cell phone. The option may remain shown but in a way that cannot be selected or used by a user. The graying out remains until the speed falls below the specified threshold.

In a different embodiment, the option to use texting may be removed entirely from the phone when the speed gets above the threshold speed, e.g., 6 miles an hour.

Another embodiment determines, however, from step 120, that the velocity cannot be detected. In this case, the user's last known location is used as a location at 145. For example if that last known location is a residential location or an office location at 150, then texting is allowed at 155. If the last known location is not an office location, the user is presumed to be in an unknown location, and texting may be blocked at 160, until the user gets to unknown or allowed location.

This system, however, prevents everyone in the car from texting. While it is really the driver who should be prevented from texting, everyone may be blocked by this system. This is done for purposes of safety. In addition, however, this will prevent not only the driver from texting, but also may prevent passengers near the driver form texting. In a train, subway or bus, all of the passengers may be prevented from texting.

Another embodiment shown in 170 detects a safe zone shown generally as 175. A safe zone may be defined by a Bluetooth area in a car, for example, where a short range transmission is caused as 176 shown in the FIG. 1. Anyone in the range of the short train range transmission 176 is defined as being in the safe zone. In the safe zone 176, texting is allowed. Anyone moving but outside the safe zone is prevented from carrying out texting. The safe zone 176 can be defined by one or more short-range Bluetooth transmitters 177 which are jammed from existing in the area 178 by a jamming line 179. The jamming line can be a directional RF jammer, or an RF shield.

Another embodiment may use, for example a line of sight device that only prevents texting of users who are within the line of sight of the device 180. The line 179 becomes a shadow line. For example, the line of sight device 180 can be an infra red detection device.

The safe zone can also be defined by a short range beacon that transmits a safe zone indication. Users in the safe zone can texts. Users outside the safe zone, e.g., the driver, cannot send texts.

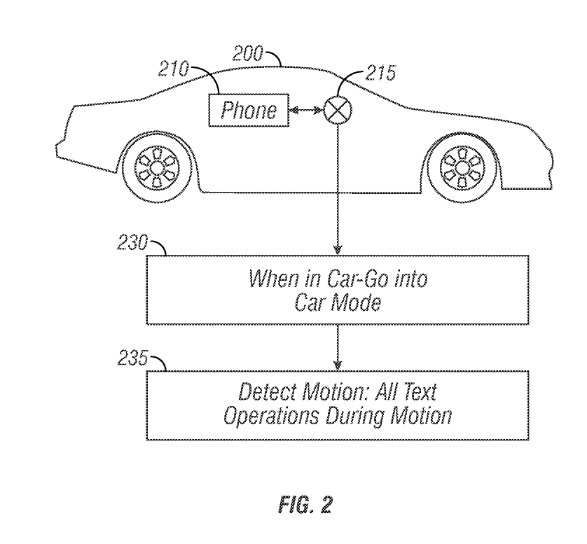

Another embodiment is illustrated in FIG. 2. In this embodiment, there is an automobile 200, and a portable phone 210, where the portable phone can be any device that enables communication. The automobile 200 includes a phone interface 215. In this embodiment, either the phone 210 detects the automobile or the automobile 200 detects the phone. When the phone 210 gets within distance of the device 215, it goes into car mode. This is shown as 230. In car mode, at 235, all text operations are terminated during the motion. This may use the flowchart of FIG. 1 or similar once the phone is detected to be in the automobile.

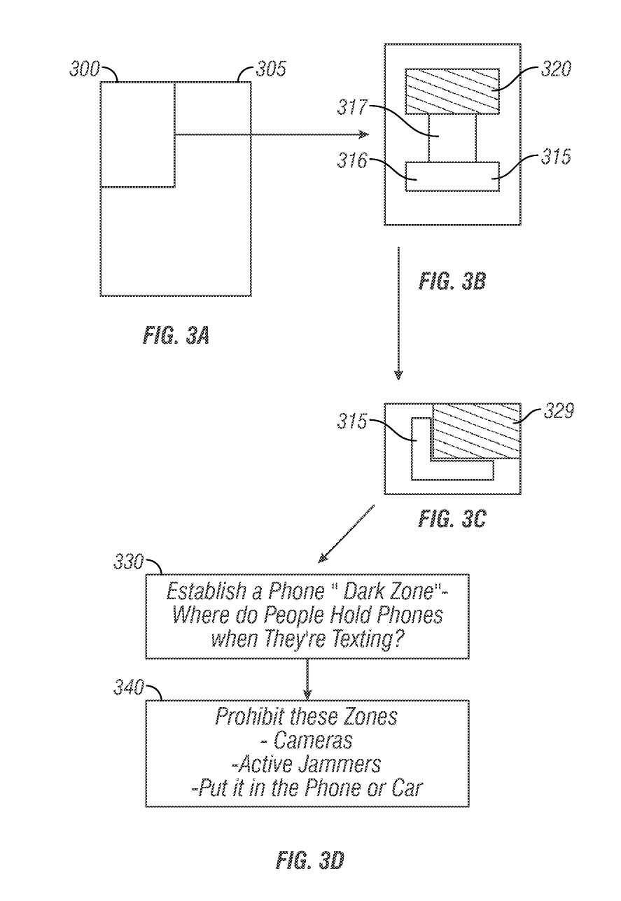

FIGS. 3A-3D illustrates a sectoring embodiment which defines multiple different sectors within the vehicle. In certain sectors the portable device, e.g., a portable phone, is allowed to operate in certain ways only when in certain locations. In other sectors, there are no limitations on where the phone can be located.

FIG. 3A shows a top view of the automobile. This shows the driver's compartment 300, and the rest of the vehicle 305. Inside the driver's compartment 300, the phone should only be in certain locations, for example, the phone should not be in front of the driver's face in a way that would indicate that the driver is using the phone for texting. Outside the driver's compartment 305, the users are freely allowed to use the phone any way they want, and in any location. Therefore, the location of the phone absolutely does not matter in these other locations.

FIG. 3B illustrates a front view of the vehicle showing the driver's seat 315, with seat pad 16 and seat back 317. Assuming the driver is sitting in the driver seat 315, the driver's face area would be within the area 320, and that phone should not be within that area 320, that is in front of the driver's face. FIG. 3C illustrates a side view of the vehicle, with the driver seat 315, and the area 320 within which the phone should not be located.

The area 320 is referred to herein as being a phone dark zone, the location where people hold their phones while texting. This sectoring technique may use the flowchart of FIG. 3D which can be executed by the processor 101 in the phone. 330 establishes or detects this dark zone area, according to the techniques above. At 340, the phone is prevented from being used in that dark zone during times of operation, for example the phone can be detected from being used in these locations in the vehicle whenever movement is detected.

Any of the techniques used in the previous embodiments may be used to detect the location of the phone within the vehicle. For example, this may use shadowed RF or line of sight to determine if, within the area 300, the phone is in front of the driver's face. Another embodiment may use a camera. The camera may be in the vehicle, pointing at the driver, and use machine intelligence to determine if the phone is in front of the driver's face. Another embodiment may use the camera in the phone to detect a face in the camera, using known face determination algorithms, and prevent use of the keyboard when the face is detected.

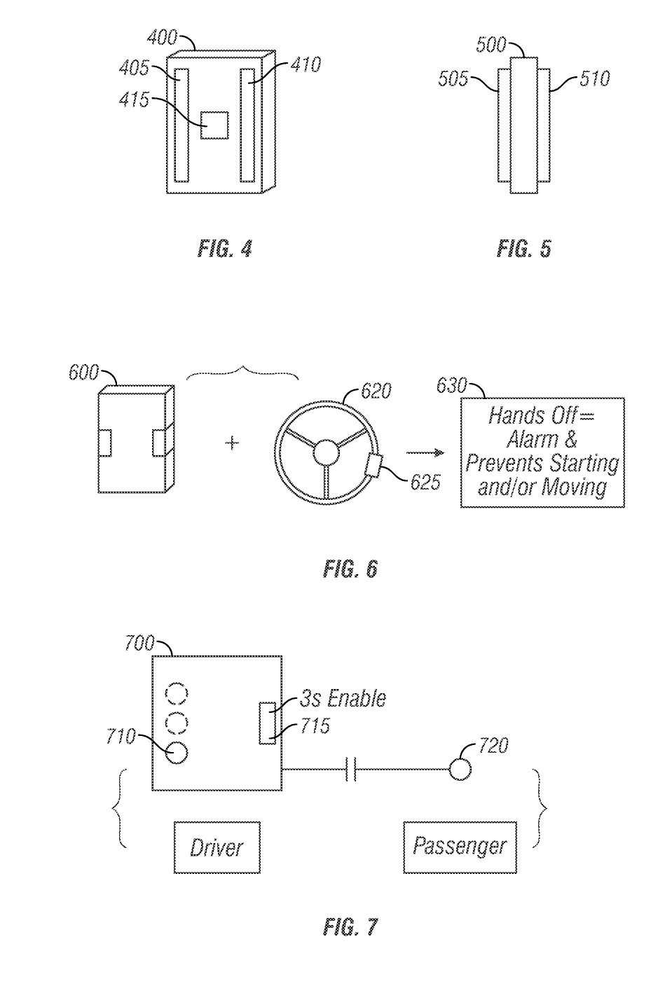

Another embodiment is illustrated with respect to FIG. 4. This embodiment is usable for any portable device that can be used in a moving vehicle. This can be used for cell phones, and also in GPS devices or other navigators which have conventionally been prevented from being used for entering addresses while the vehicle is in motion.

The inventor recognized that many people resent being prevented from entering destination addresses into their GPS whenever the vehicle is in motion. For example, even when there is a passenger within the vehicle, the GPS is still prevented from being used while in motion, out of fear that the driver is the one setting the destination. This can even be dangerous, since this may necessitate stopping the vehicle to enter a destination, and the location where the vehicle is stopped may be dangerous.

In recognition of this and the above problem, also the problem that exists with cell phones as described above—to prevent a user from operating a keyboard while they are driving; however allowing other passengers to operate that keyboard. However, while one user is driving, the passenger should still be allowed to operate the keyboard. This realization has given rise to embodiments in which the system detects who is operating the keyboard. Only the driver in this embodiment is prevented from operating the keyboard. Other users in the vehicle are allowed to operate the keyboard. The following embodiments, however determine other ways of excluding the driver. A set of embodiments described herein requires a 2 hands mode. The basic idea is that you need two hands to operate the portable device in a “driver mode”. In one embodiment, the driver mode might be only when movement is detected. This makes it more difficult to operate while driving, since it will require two hands to operate.

An embodiment shown in FIG. 4 uses a portable device 400 which includes touch strips 405, 410. The touch strips 405, 410 detect touching by human hands. For example, these may be capacitive touch strips or inductive touch strips which detect an impedance that indicates that a human hand is toucing touched them. 400 shows a smart phone housing, but it should be understood that the housing can be any portable device with a keyboard. In the embodiment, a controller 415 controls the operation of the device. The controller sends this touch to the two touch strips 405, 410. The touch strips should be far enough apart or otherwise positioned so that the user will need to use two hands in order to touch both touch strips 405, 410. This makes it much less likely that a user can operate the device while driving. A driver has conventionally kept one hand on the steering wheel, the other hand on the device. The driver mode of this device requires that the user keep two hands on the device in order to program or in order to use the keyboard. For example that way the user cannot dial a phone number with the keyboard unless they can put two hands on the device. In driver mode, a user cannot send a text or enter an address into the GPS unless there are two hands on the keyboard or device.

FIG. 4 shows detecting this on the back of the device, but this can also be detected in other locations on the device, in other embodiments. FIG. 5 illustrates the touch pads on the phone 500 on the front of the device as 505 and on the back of the device as 510. This requires the user to touch both the front and back of the device simultaneously.

The touch sensors can also be on the front of the device as shown in FIG. 6. FIG. 6 may also require interaction with a driven vehicle. In FIG. 6, there are sensors on the phone, but also a sensor on the steering wheel 620 of the vehicle which has a steering wheel sensor 625. In this embodiment, a processor in the vehicle communicates at 630 with the portable device 600. Communication may indicate to the portable device that the steering wheel is being touched, and the phone may indicate that the phone is being touched properly. This embodiment requires 3 touches—both hands on the portable device, and one hand on the steering wheel. A user with two hands could not touch all three places at once.

The embodiment of FIG. 6 can be used with any of the previously disclosed embodiments, including the embodiments of FIG. 4, the car detecting embodiment of FIG. 2, and the sector embodiment of FIG. 3A-3C.

In another embodiment, the controller 415 may detect a capacitance or inductance that has a value indicating that the user is touching with two hands, rather than with one hand. One way to thwart the driver mode embodiments might be to try and hold the portable device in a way where one hand went across both sensors 405, 410. However, this would create a different capacitance or inductance value between the sensors than the one that would be created by two different hands on the device. Therefore in an embodiment, the controller 415 detects a value from the sensors 405, 410 that indicates that the user is touching with two separate hands.

The embodiments up until now have referred to stand-alone electronic devices which are portable. However, the embodiment of FIG. 7 adopts all of these previously disclosed techniques to be used on a car mounted electronic device. For example, the device may have a screen 700 which is used to accept commands. The screen 700 requires two hands to touch the screen in order to accept commands on the screen while the automobile is moving. In one embodiment, a user needs to touch two places on the screen, for example a key that it enters the command 710 as well as an enable key 715. When the enable key 715 is touched, the screen is activated, but the command can only be accepted if the user is touching both positions at once.

In another embodiment, there may be a button 720 in the area of the passenger that cannot be easily reached by a driver, and which needs to be pressed at the same time as a button is pressed on the screen 700. Passenger therefore would keep one hand on the button 720 to enable the screen, but the screen would only be enabled while the passenger's hand was on the button. Alternatively, 720 can just be a sensor that detects the passenger's presence.

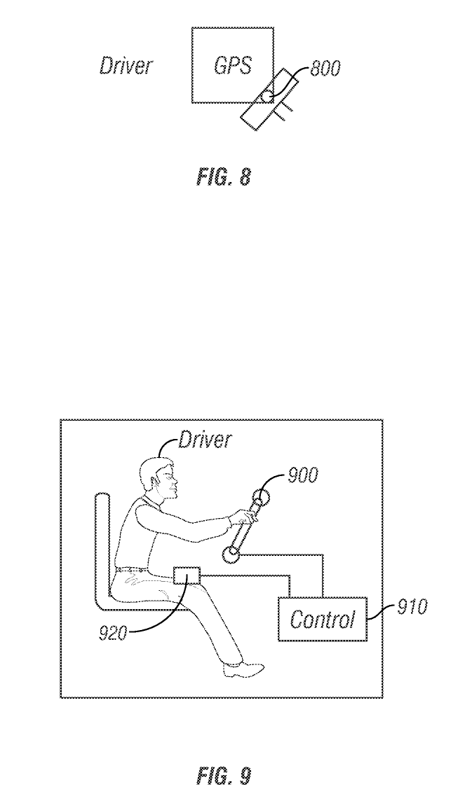

Another embodiment is shown in FIG. 8. According to this embodiment, the devices, which can be the built-in device of FIG. 7 or any of the previous portable devices, include a camera 800 which carries out face recognition. However, the face recognition is carried out not to determine a specific faith, but rather to determine the presence of a face, e.g, two eyes and a mouth. In this embodiment, the camera allows entry on the keyboard only if the face detection is detected as leaning in the direction from the passenger seat towards the device, but does not allow entry of information on the keyboard when the face is detected as leaning in the direction from the driver's seat.

Another embodiment uses a biometric technique, shown in FIG. 9. In this embodiment, whenever the vehicle starts to operate, the driver's face is detected by a camera 900. That camera 900 may be located for example on the steering wheel or dashboard, and may take a picture of the drivers face. For example, this picture may be taken anytime the vehicle is placed into a driving mode. Once taking the picture of the drivers face, the device stores that picture as being representative of the face that cannot use keyboard during vehicle motion. For example, this face shot may be may be stored in the vehicle in the vehicle controller 910.

Thereafter, users who want to use operations in the vehicle while driving, cannot do so if their face matches to the previously registered face. This may use face recognition biometric software, such as Lenovo's “Veriface” software, or other.

In one embodiment, the vehicle and the device, e.g., the phone, may communicate. For example, the vehicle may communicate information indicative of the driver's face to all portable devices within the area of the vehicle, e.g, to the portable device 910. In an alternative embodiment, the portable devices may each request information indicative of the driver face, any time that a keyboard operation is detected in a moving vehicle. Therefore, the GPS with face detection will not allow programming by the driver whose face has last been registered as being the driver by obtaining a picture of the driver in the driver's seat. Also, none of the phones within the range of the vehicle will allow texting to be carried out when these phones when the camera in these phones see the face that is the same as the face that was used for start up of the vehicle.

FIG. 10 shows an embodiment where a portable device 1000 has a display 1005 and a keyboard 1010. The portable device also has an operation circuit which may be the processor that operates the main functions of the device. For example, this may be a microprocessor, a microcontroller, or an application specific integrated circuit. Part of the flowchart carried out by the operation circuit 1020 is also illustrated in FIG. 1. In this embodiment, as in the others, portable device 1000 can be any of a number of different kinds of portable devices, e.g., a portable phone or PDA device, or a portable GPS device.

At 1030, the operation circuit detects whether a user is actually in the driver's seat of an automobile. This is done according to the techniques described herein. This can be done by detecting an electrical value, e.g., a capacitance value, to ground. Capacitance to ground detection has been used, for example, for electrical testers such as the fluke 1AC-A1 for detecting whether an wire or outlet is electrically energized. Capacitance detection is also used for example in certain shredding machines so that when a user gets their body too close to the operative part of the shredder, the shredder is prevented from shredding. Capacitance detection is used in many different applications. However, here the capacitive detection is used in a completely new way to obtain a result that was never contemplated by the prior art. A capacitance detector will detect a certain amount of capacitance to ground if a user is touching the capacitance detector. The amount of capacitance depends on the user's ground connection. Capacitance may be detected through the user's body to ground.

An embodiment describes using this system to discriminate between the capacitance to ground of a user in the passenger seat of a vehicle, and a capacitance to ground of a user in the driver's seat of the vehicle. Embodiments describe a number of different ways of carrying this out.

Another embodiment may detect operation in or near a driver area of a bus or truck, and prevent operation in that area. The detection of use in a bus or truck will cause entry into a mode where the operation is more strictly controlled than the analogous operation in a vehicle.

At 1030, when the detection is made that the user is in the driver seat, a T/O operation is effective at 1040. The T/O operation in previous embodiments has been used for preventing operation of, for example, a keyboard. In this embodiment, the T/O operation may be used as in any of the previous embodiments to shut off the phone, or, for example, to prevent keyboard use.

Another embodiment described herein operates to blank the screen on the phone when the TO is detected. This has some inherent advantages. Specifically when the driver or the user is detected as sitting in the driver seat, the phone screen is blank. This prevents an operator/user from texting or otherwise using the keyboard in a way that would distract the operator/user from the road. Also, however, this has the other unexpected advantage of conserving battery life in the portable device, e.g., the phone. Since the display of the phone is turned off, the battery does not have to illuminate the keyboard. This is one of the major power drains in any portable device. This also has the advantage of preventing the user from using the portable device. This therefore produces dual advantages of power drain and also prevention of certain operations.

As an alternative to turning off the display, the system may disable the keyboard, so that the keyboard cannot be used to enter data. However, turning off the display may produce advantages as described above.

At. 1050, if a user is detected who is not in the driver seat, the portable device is allowed to operate normally.

FIG. 11 illustrates how the portable device 1000 can include a number of “electrodes” extending there are cross. Each electrode such as 1105 extends all the way across a surface of the portable device from one edge of the perimeter to the other. The electrode 1105 is adjacent to another electrode 1110. A distance 1115 may be between two adjacent electrodes. In one embodiment, the electrodes also extend on edges of the device such as edge surface 1001. The electrodes may also extend around the back of the device. The purpose is to make the distances between electrodes close enough so that a user cannot touch the phone anywhere without touching the electrodes. In one embodiment, the distance 1115 may be 1 cm, however any distance between 0.2 cm and 5 cm between electrodes may be optimal. The electrode 1120 extends across an area of the screen. In one embodiment, this may simply extend around the phone and not touch the screen. However, another embodiment uses an electrode part 1125 across the screen formed of a transparent conducting material such as indium tin oxide, or ITO.

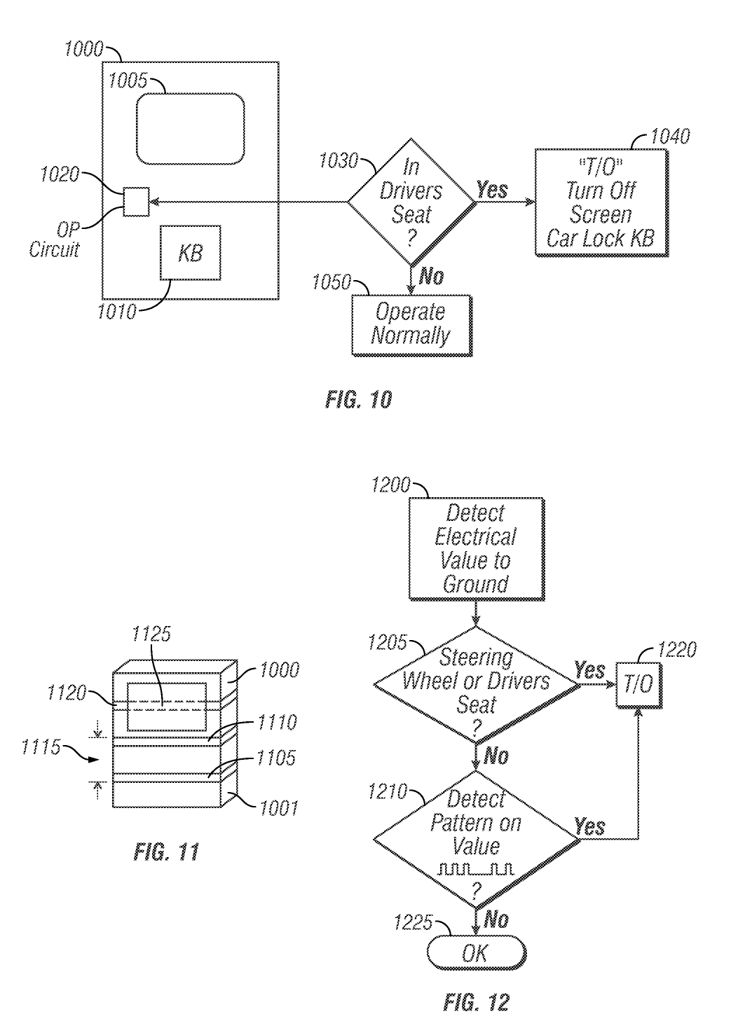

FIG. 12 shows a detailed flowchart carried out by the operation circuit 1020. At 1200, the system detects an electrical value to ground. In this embodiment, the electrical value to ground may be capacitance, however other electrical values to ground such as voltage, inductance, resistance, impedance, resonant value, or others can be used. The system as described herein may detect capacitance that similar techniques can be used to detect other values. Or other to other whatever values I guess is the right word. In this embodiment, the automobile must be specially configured in a way such that there is a different electrical value in the area of the driver's seat than there is in other areas of the vehicle. For example, one embodiment described herein describes detecting a capacitance to ground of the steering wheel as compared with a capacitance to ground when simply touching the non-driver's seat.

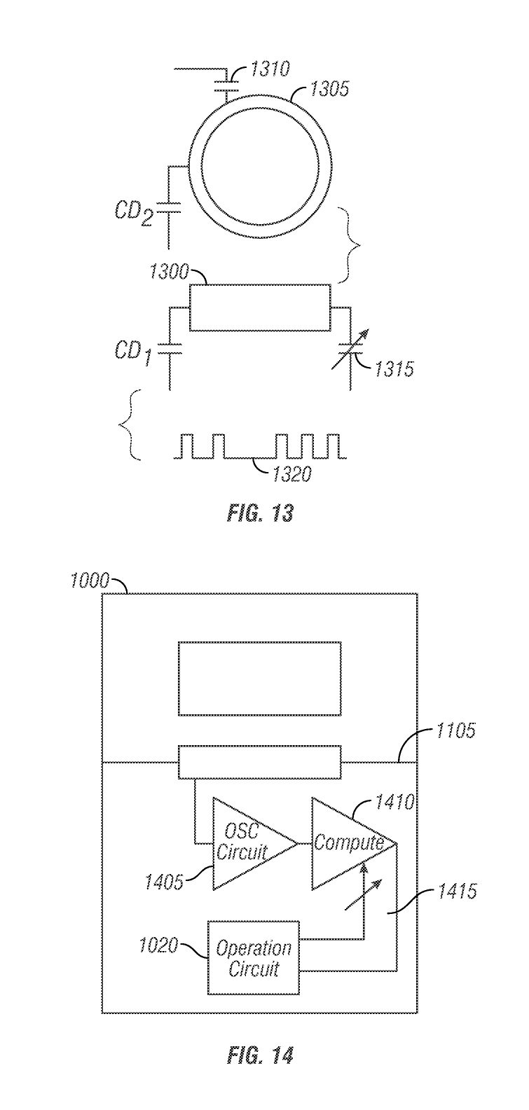

FIG. 13 illustrates this embodiment where a driver seat 1300 has a first capacitance to ground shown as C_{D1}. However, the steering wheel 1305 of the vehicle as a second capacitance to ground shown as C_{D2}. By detecting whether CD1 or CD2 exists, 1205 can detect whether the user of the portable device is in the driver's seat.

In one embodiment, the detection may be carried out from the portable phone. For example, the portable phone may itself detect the electrical value to ground, and then may turn off operation if that electrical value to ground indicates that the portable device user is in the driver's seat.

Another embodiment may induce a special signal onto the steering wheel or driver seat, shown as 1310. This signal may be, for example, a special voltage induced to change the capacitance, or may be a pattern of capacitance change shown generically as 1315 induced on the driver's seat. The pattern of capacitance change may be as shown as 1320. Any of these special values or patterns can be detected as 1210. In the embodiment, either the different value or the pattern can be detected, to accommodate a number of different possible vehicles. Moreover, in the embodiment, different menus can be used for updating values so that different patterns for vehicles can be induced and/or detected.

If either 1205 detects touching the steering wheel or driver seat or the pattern is detected at 1210, then the T/O operation is carried out at 1220. If not, the operation is declared to be okay at 1225 and the system is allowed to operate normally.

FIG. 14 illustrates a simplified schematic of detecting the capacitance. The phone 1000 is shown with any and/or of the electrodes 1105 connected to an oscillation circuit 1405. For example, the oscillation circuit may be an LC resonant circuit that oscillates in proportion to an inductance L and capacitance C value of the LC circuit, and where the circuit exhibits resonance at certain frequencies. Therefore, the capacitance on 1105 changes the output of the RC circuit. This capacitance change is detected by comparator circuit 1410. The comparator circuit 1410 may have a threshold shown as 1415 which is itself set by the oscillation circuit 1020. The comparator also produces an output 1415 which goes to the oscillation circuit and is used by the oscillation circuit to set the specific value of capacitance.

The above has described detecting capacitance, however other electrical or magnetic, inductive or other values can be detected as electrical values at 1200. Any value that can be electrically detected can be used.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of portable devices can be protected in this way. While this describes protection against texting, it can be used to protect against any subset of actions and/or activities that can be carried out with a keyboard, including texting, dialing, emailing, or any other action.

The operations are described as being carried out by the cell phone, but they can also be carried out by the vehicle. For example, the vehicle can have a controllable cell phone jammer that is turned on to jam cell phone operations when a user attempts to text. Alternatively, the cell phone itself can be blocked and turned off.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, display port, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A portable device, comprising:
a user interface that allows entry of information into said device and viewing of information, said user interface including a control keyboard, and a display that displays information including information entered by said control keyboard;
a controller that controls operations of the portable device; and
a detector that detects a condition whereby a user should be prevented from using at least one function of said portable device,
said controller connected to said detector, and said controller operating to prevent at least one of at least one of said entry of information or said display information in response to said detector that detects a condition whereby a user should be prevented from using said portable device.

2. A device as in claim 1, wherein said portable device is a portable phone, said user interface controls functions of said phone including dialing numbers and sending text messages.

3. A device as in claim 1, wherein said portable device is a portable navigation device, and said user interface controls entering destinations into said portable navigation device.

4. A device as in claim 1, wherein said controller turns off said display, responsive to detecting the condition whereby the user should be prevented from using a controller keyboard.

5. A device as in claim 1, wherein said detector includes a plurality of electrodes which detect an electrical value, and where said electrical value is used to determine whether the user should be prevented from using the portable device.

6. A device as in claim 5, wherein said electrical value is detected to be occurring in a specified pattern, and prevents the user from using the at least one function of said portable device only when occurring in the specified pattern.

7. A device as in claim 1, wherein said detector detects a condition that occurs when the user is in the driver seat of a vehicle, and where that condition is not detected when said user is not in the driver seat of said vehicle.

8. A device as in claim 5, where said electrodes are spaced on said device in a way that prevents said device from being touched without touching said electrodes.

9. A device as in claim 5, wherein said detector detects a capacitance to ground.

10. A portable device, comprising:
a user interface that allows entry of information into said device and viewing of information, said user interface including a control keyboard, and a display that displays information including information entered by said control keyboard;
at least one sensor, that senses a condition that occurs when the user is in the driver seat of a vehicle, and where that condition is not detected when said user is not in the driver seat of said vehicle; and
a controller that prevents at least one operation that is carried out using said user interface responsive to sensing the condition whereby the user is in the driver seat.

11. A device as in claim 10, wherein said controller turns off said display responsive to said sensing.

12. A device as in claim 10, wherein said portable device is a portable phone, and said user interface controls functions of said phone including dialing numbers and sending text messages.

13. A device as in claim 1, wherein said portable device is a portable navigation device, and said user interface controls entering destinations into said portable navigation device.

14. A device as in claim 10, wherein said sensor includes a plurality of electrodes which detect an electrical value, and where said electrical value is used to determine whether the user should be prevented from said at least one operation.

15. A device as in claim 14, wherein said electrical value is detected to be occurring in a specified pattern, and prevents the user from at least one operation only when occurring in the specified pattern.

16. A device as in claim 14, where said electrodes are spaced on said device in a way that prevents said device from being touched without touching said electrodes.

17. A device as in claim 10, wherein said sensor senses sitting on a driver's seat.

18. A device as in claim 10, wherein said sensor senses touching of a steering wheel.

19. A vehicle comprising:
A first value creating part, connected to a driver's part of a vehicle, and not connected to non driver's parts of the vehicle, said first value creating part creating an electrically detectable value in said driver's part that is not created in said non-driver's parts.

20. A vehicle as in claim 19, wherein said value is a capacitance value that is different in said driver's part of a vehicle than it is in non driver's parts of the vehicle.

21. A vehicle as in claim 19, wherein said value is a pattern of electrically detectable values that is different in said driver's part of a vehicle than it is in non driver's parts of the vehicle.
